(19) United States
(12) Patent Application Publication
(10) Pub. No.: US 2013/0114400 A1
(43) Pub. Date: May 9, 2013

(54) ETHERNET LOOP LOCATING METHOD, SWITCHING DEVICE AND SYSTEM

(71) Applicants: Yan ZHANG, Nanjing (CN); Ying XIE, Nanjing (CN)

(72) Inventors: Yan ZHANG, Nanjing (CN); Ying XIE, Nanjing (CN)

(73) Assignee: HUAWEI TECHNOLOGIES CO., LTD., Shenzhen (CN)

(21) Appl. No.: 13/549,053

(22) Filed: Jul. 13, 2012

(30) Foreign Application Priority Data
Nov. 4, 2011 (CN) 201110345958.0

(51) Int. Cl. H04L 12/437

(52) U.S. Cl. 370/224

(57) ABSTRACT

The embodiments of the present disclosure relate to the field of communications and provide an Ethernet loop locating method, a switching device, and a system to locate loop fault ports precisely. The switching device receives an Ethernet frame, learns a MAC address according to a source MAC address of the Ethernet frame, and determines a learned associated port of the MAC address as a first port of the MAC address; uses a port after hopping as a second port of the MAC address when the learned associated port of the MAC address undergoes hopping for a first time after the MAC address is learned; and determines the second port as a loop fault port if the total number of hops of the learned associated port of the MAC address in a specified time is greater than or equal to a preset threshold.

### CROSS-REFERENCE TO RELATED APPLICATION

This application claims priority to Chinese Patent Application 201110345958.0, filed on Nov. 4, 2011, which is hereby incorporated by reference in its entirety.

### FIELD

The present disclosure relates to field of communication, and in particular, to an Ethernet loop locating method, a switching device, and a system.

### BACKGROUND

When the Ethernet line connection is incorrect or the network device configuration is incorrect, an Ethernet loop may appear, and a broadcast storm will occur in the Ethernet loop area, which will affect services of the entire network seriously.

To tackle the broadcast storm caused by the Ethernet loop, network maintainers expect the Ethernet switch to locate a related port of the loop fault automatically at high precision, and block or cut off a relevant port when an Ethernet loop fault occurs so as to avoid impact onto the entire network.

To minimize the risk of loop faults, a ring network protection protocol such as a Spanning Tree Protocol (Spanning Tree Protocol in English, STP for short) or an Ethernet ring protection switching (Ethernet Ring Protection Switching in English, ERPS for short) is generally deployed in an Ethernet ring network. The ring network protection protocols enable calculation of a logically loop-free network in a network physically connected into a loop. However, the ring network protection protocol such as the STP or ERPS prevents logical loops of the network only if the configuration is correct. If line connection or configuration is incorrect in the network, or a loop is formed inside an accessed subscriber network, the ring network protection protocol such as the STP or ERPS is unable to overcome the loop fault.

A common method for detecting and locating an Ethernet loop fault in the prior art is: The network device sends a group of special detection messages, and checks whether the messages are received by the same port repeatedly. If the messages are received by the same port repeatedly, it is determined that a loop occurs on the port. The defect of the solution is: When a loop fault occurs on the Ethernet, all ports on the loop generally receive the returned message. Consequently, although all ports that suffer the loop fault are found, specific faulty ports are not located precisely; meanwhile, if an Ethernet switch works in an environment with dense ports or plenty of virtual local area networks (Virtual Local Area Networks in English, VLANs for short) are deployed, the Ethernet switch needs to send plenty of detection messages, which imposes intense pressure on the device and network and affects the Ethernet performance seriously.

### SUMMARY

Embodiments of the present disclosure provide an Ethernet loop locating method, a switching device, and a system to locate loop fault ports precisely.

An aspect of the embodiment of the present disclosure provides an Ethernet loop locating method, which includes:

receiving an Ethernet frame, learning a MAC address according to a source MAC address of the Ethernet frame, and determining a learned associated port of the MAC address as a first port of the MAC address;

using a port after hopping as a second port of the MAC address when the associated port of the MAC address undergoes hopping for a first time after the MAC address is learned; and

determining the second port of the MAC address as a loop fault port if the total number of hops of the associated port of the MAC address in a specified time is greater than or equal to a preset threshold.

Another aspect of the embodiment of the present disclosure provides an Ethernet switching device, which includes:

a receiving module, configured to receive an Ethernet frame;

a MAC address learning module, configured to learn a MAC address according to a source MAC address of the Ethernet frame, and determine a learned associated port of the MAC address as a first port of the MAC address; and

a loop fault determining module, configured to: use a port after hopping as a second port of the MAC address when the associated port of the MAC address undergoes hopping for a first time after the MAC address is learned; and determine the second port of the MAC address as a loop fault port if the total number of hops of the associated port of the MAC address in a specified time is greater than or equal to a preset threshold.

A further aspect of the embodiment of the present disclosure provides an Ethernet system, which includes at least one Ethernet switching device.

The Ethernet switching device is configured to: receive an Ethernet frame, learn a MAC address according to a source MAC address of the Ethernet frame, and determine a learned associated port of the MAC address as a first port of the MAC address; use a port after hopping as a second port of the MAC address when the associated port of the MAC address undergoes hopping for a first time after the MAC address is learned; and determine the second port of the MAC address as a loop fault port if the total number of hops of the associated port of the MAC address in a specified time is greater than or equal to a preset threshold.

Through the Ethernet loop locating method, switching device and system provided by the embodiments of the present disclosure, after an Ethernet frame is received, a MAC address is learned according to a source MAC address of the Ethernet frame, and an associated port of the source MAC address is determined as a first port of the MAC address; a port after hopping is used as a second port of the MAC address when the associated port of the MAC address undergoes hopping for a first time after the MAC address is learned; and the second port of the MAC address is determined as a loop fault port if the total number of hops of the associated port of the MAC address in a specified time is greater than or equal to a preset threshold. In this way, after a loop fault occurs on the Ethernet, the loop fault port can be located quickly and precisely without the need of sending a detection message and waiting for a returned message as in the prior art.

### BRIEF DESCRIPTION OF THE DRAWINGS

To illustrate the technical solution of the present disclosure or the prior art more clearly, the following outlines the accompanying drawings used in the description of the embodiments of the present disclosure or the prior art. Apparently, the accompanying drawings outlined below are illustrative rather than exhaustive, and persons of ordinary skill in the art can derive other drawings from them without making any creative effort.

FIG. 1 is a schematic diagram of an Ethernet loop in the prior art;

FIG. 2 is a schematic diagram of another Ethernet loop in the prior art;

FIG. 3 is a schematic flowchart of an Ethernet loop locating method according to an embodiment of the present disclosure;

FIG. 4 is a schematic flowchart of another Ethernet loop locating method according to an embodiment of the present disclosure;

FIG. 5 is a schematic flowchart of another Ethernet loop locating method according to an embodiment of the present disclosure;

FIG. 6 is a schematic structural diagram of an Ethernet switching device according to an embodiment of the present disclosure; and

FIG. 7 is a schematic structural diagram of another Ethernet switching device according to an embodiment of the present disclosure.

### DETAILED DESCRIPTION OF THE EMBODIMENTS

The following detailed description is given in conjunction with the accompanying drawings to provide a thorough understanding of the present disclosure. Evidently, the drawings and the detailed description are merely representative of particular embodiments of the present disclosure rather than all embodiments. All other embodiments, which can be derived by those skilled in the art from the embodiments given herein without making any creative effort, shall fall within the protection scope of the present disclosure.

In an Ethernet with a loop, hopping of an Ethernet switch port varies with the location of an Ethernet switch in the network. Generally, the location of a switch in the network has the following situations:

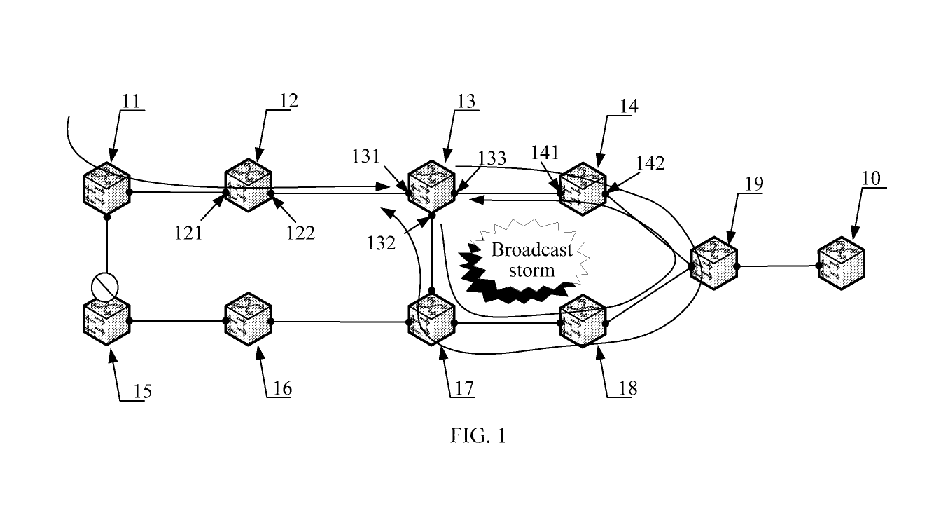

As shown in FIG. 1, the Ethernet includes a switch 11, a switch 12, a switch 13, a switch 14, a switch 15, a switch 16, a switch 17, a switch 18, a switch 19, and a switch 10. The ring network protection protocol blocks the path from the switch 11 to the switch 15. The switch 13, the switch 14, the switch 17, the switch 18, and the switch 19 form a loop.

When a switch is not on the loop, taking the switch 12 as an example, an Ethernet frame sent by a specific source station is forwarded by the switch 11 to the switch 12, and, after being forwarded by the switch 12, the Ethernet frame passes through the loop and is forwarded back through a port 122. Theoretically, an original port pointed at by a MAC address forwarding table is a trusted port, and the original port is the port 121 that receives the Ethernet frame for the first time. Let the port 121 be a first port of the switch 12. The port 121 and the port 122 are both MAC address associated ports that undergo hopping. Let the port 122 be a second port. Evidently, the second port faces the loop.

When the switch is in the loop and is not connected to the switches outside the loop, taking the switch 14 as an example, due to existence of the loop, the switch 13 sends an Ethernet frame to both the switch 14 and the switch 17, and the Ethernet frame is forwarded along the loop clockwise and counterclockwise respectively. The port 141 and the port 142 of the switch 14 are both MAC address associated ports that undergo hopping. Because the port 141 is the port that receives the Ethernet frame for the first time, let the port 141 be the first port, and therefore, the port 142 is the second port. Evidently, the second port is a port in the loop.

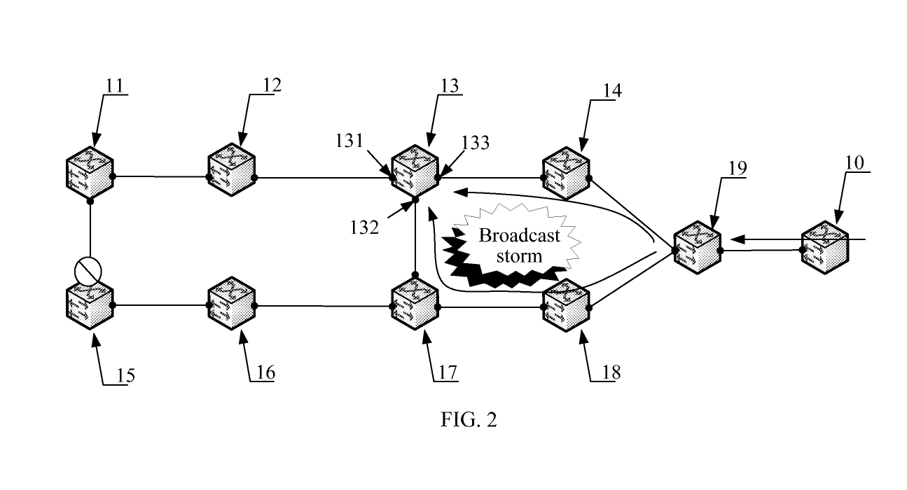

When a switch is in the loop and connected with a switch outside the loop, taking the switch 13 as an example, an Ethernet frame sent by a specific source station is forwarded by the switch 11 and the switch 12 to the port 131 of the switch 13, and the switch 13 sends the Ethernet frame to both the switch 14 and the switch 17 through the port 133 and the port 132 respectively, and receives the Ethernet frame forwarded by the switch 17 and the switch 14 through the port 133 and the port 132 respectively. The port 131, the port 132 and the port 133 of the switch 13 are all MAC address associated ports that undergo hopping. Let the port 131 that receives the Ethernet frame for the first time be a first port. In the order of hopping time, let the port 132 be a second port and let the port 133 be a third port. The hopping order is not fixed between the port 132 and the port 133. Therefore, it is also practicable to let the port 132 be the third port and let the port 133 be the second port. Evidently, the second port is a port in the loop. Specially, if the Ethernet frame sent by a specific source station is forwarded by the switch 10 into the loop, as shown in FIG. 2, the switch 13 may be in a scenario equivalent to that the switch 13 is in the loop and is not connected to any switch outside the loop, and the second port is still a port in the loop.

In summary, regardless of the scenario, except the port that receives the Ethernet frame for the first time, starting from receiving the Ethernet frame, the MAC address associated port that undergoes hopping for the first time (namely, the second port above) is necessarily a port in the loop or a port facing the loop.

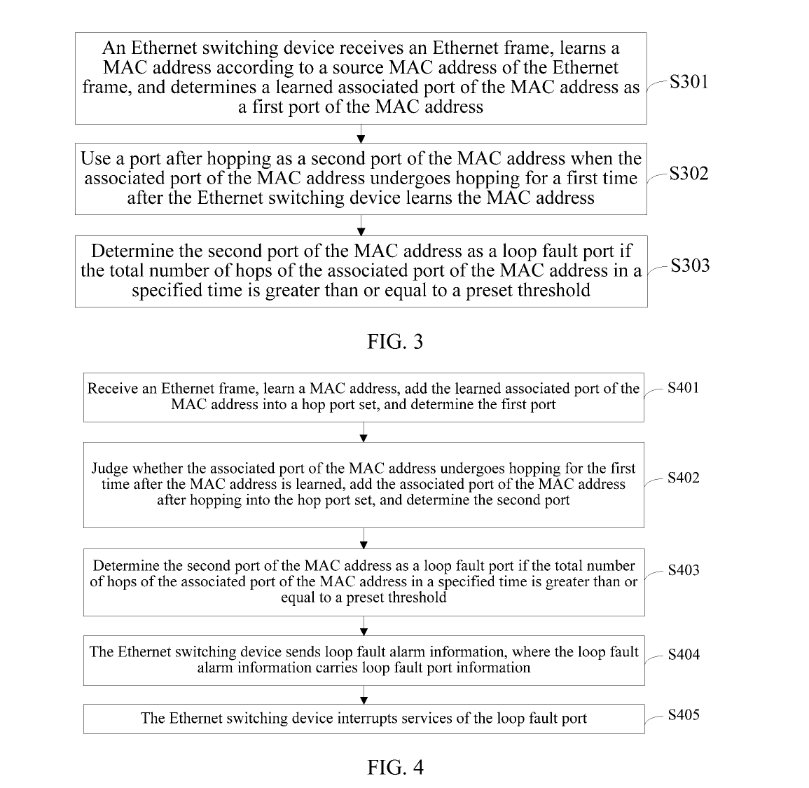

As shown in FIG. 3, an Ethernet loop locating method provided in an embodiment of the present disclosure includes the following steps:

S301: An Ethernet switching device receives an Ethernet frame, learns a MAC address according to a source MAC address of the Ethernet frame, and determines a learned associated port of the MAC address as a first port of the MAC address.

S302: Use a port after hopping as a second port of the MAC address when the associated port of the MAC address undergoes hopping for a first time after the Ethernet switching device learns the MAC address.

S303: Determine the second port of the MAC address as a loop fault port if the total number of hops of the associated port of the MAC address in a specified time is greater than or equal to a preset threshold.

Through the Ethernet loop locating method provided in the embodiment of the present disclosure, after an Ethernet frame is received, a MAC address is learned according to a source MAC address of the Ethernet frame, and an associated port of the source MAC address is determined as a first port of the MAC address; a port after hopping is used as a second port of the MAC address when the associated port of the MAC address undergoes the hopping for a first time after the MAC address is learned; and the second port of the MAC address is determined as a loop fault port if the total number of hops of the associated port of the MAC address in a specified time is greater than or equal to a preset threshold. In this way, after a loop fault occurs on the Ethernet, the loop fault port can be located quickly and precisely without the need of sending a detection message and waiting for a returned message as in the prior art. The precise locating of the loop fault port shortens the troubleshooting time of the loop, and quickens service recovery.

The following elaborates the Ethernet loop locating method illustrated in FIG. 3 with reference to the network architecture shown in FIG. 1.

Taking the switch 12 as an example, from the switch 11, the switch 12 receives an Ethernet frame sent by a specific source station, and learns a MAC address according to a source MAC address of the Ethernet frame. Because a learned associated port of the MAC address is the port 121 used by the switch 12 for receiving the Ethernet frame, it is determined that the port 121 is the first port of the MAC address.

When the associated port of the MAC address undergoes hopping for a first time after the MAC address is learned, namely, when the associated port of the MAC address hops into the port 122 (the second port of the MAC address), the switch 12 starts timing and compares whether the total number of hops of the associated port of the MAC address in a specified time is greater than or equal to a preset threshold. The timing length is the preset specified time. For example, the specified time may be preset to 10s, and the preset threshold may be set manually, to 20, for example. That is, once the associated port of the MAC address hops into the port 122, the timing begins, and lasts for 10s. If the total number of hops of the associated port of the MAC address is less than 20 within the 10s as counted by the switch 12, the timing stops, and the hop count value is reset to zero without any other processing. The switch 12 enters a next judgment cycle, and waits for a next hop of the associated port of the MAC address. If the total number of hops of the associated port of the MAC address in the 10s is greater than or equal to 20, it is determined that a loop fault occurs, and that the port 122 (the second port of the MAC address) is a loop fault port. Moreover, the port 122 (the second port of the MAC address) is a port facing the loop.

Further, as shown in FIG. 4, on the basis of illustration in FIG. 3, another Ethernet loop locating method provided in an embodiment of the present disclosure includes the following steps:

S401: An Ethernet switching device receives an Ethernet frame, learns a MAC address according to a source MAC address of the Ethernet frame, adds a learned associated port of the MAC address into a hop port set, and determines the learned associated port of the MAC address as a first port of the MAC address.

Specifically, after the learned associated port of the MAC address is added into the hop port set, an adding serial number of the associated port of the MAC address may be set to 1, and the port 1 is the first port of the MAC address. The hop port set includes all associated ports of the MAC address that undergo hopping.

S402: When the associated port of the MAC address undergoes hopping for the first time after the MAC address is learned, the Ethernet switching device adds the associated port of the MAC address after hopping into the hop port set, and uses the port after hopping as a second port of the MAC address; when the associated port of the MAC address undergoes hopping not for the first time, if the associated port of the MAC address after hopping is not in the hop port set, the Ethernet switching device adds the associated port of the MAC address after hopping into the hop port set.

Specifically, when the associated port of the MAC address undergoes hopping for the first time, the Ethernet switching device adds the associated port of the MAC address after hopping into the hop port set, and sets the adding serial number of the associated port of the MAC address after hopping to 2. When the associated port of the MAC address undergoes hopping not for the first time, and the associated port of the MAC address after hopping is not in the hop port set, after adding the associated port of the MAC address after hopping into the hop port set, the Ethernet switching device may set the serial number of the associated port of the MAC address in the order of joining the hop port set. The port 2 is the second port of the MAC address.

S403: Determine the second port of the MAC address as a loop fault port if the total number of hops of the associated port of the MAC address in a specified time is greater than or equal to a preset threshold.

After the Ethernet switching device adds the associated port of the MAC address after hopping into the hop port set, the port with the adding serial number being 2 is the second port of the MAC address.

S404: The Ethernet switching device sends loop fault alarm information, and the loop fault alarm information carries loop fault port information.

S405: The Ethernet switching device interrupts services of the loop fault port.

Note that the order between step S404 and step S405 may be random. That is, step S404 is performed before step S405, or step S405 is performed before step S404; or step S404 and step S405 are performed simultaneously. In FIG. 4, it is assumed that step S404 is performed before step S405.

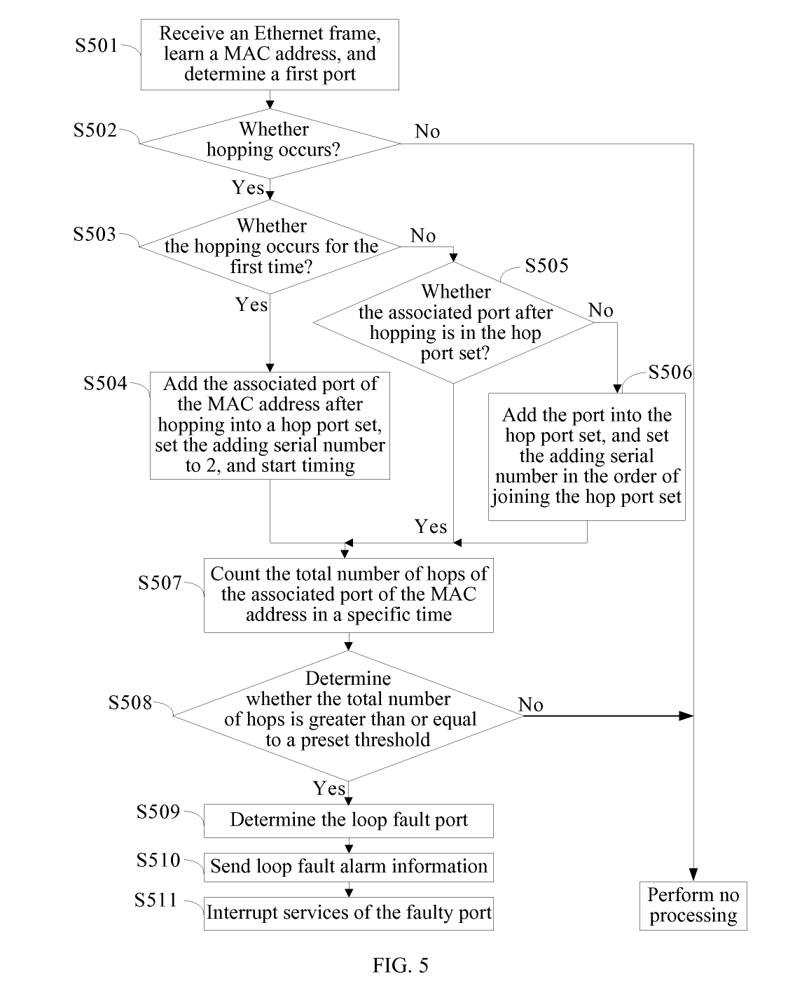

The following describes the Ethernet loop locating method shown in the embodiment FIG. 3 of the present disclosure with reference to FIG. 5, taking the switch 13 in FIG. 1 as an example.

S501: The switch 13 receives an Ethernet frame, learns a MAC address according to the MAC address of the Ethernet frame, and determines a first port.

Specifically, after the MAC address is learned, the associated port 131 of the learned MAC address is added into the hop port set, and the adding serial number of the port 131 is set to 1. The hop port set includes all associated ports of the MAC address that undergo hopping.

S502: The switch 13 checks whether the associated port of the MAC address undergoes hopping. If the associated port of the MAC address does not undergo hopping, no processing is performed; if the associated port of the MAC address undergoes hopping, step S503 is performed.

S503: When the associated port of the MAC address undergoes hopping for the first time, the switch 13 performs step S504; when the associated port of the MAC address undergoes hopping not for the first time, the switch 13 performs step S505.

S504: The switch 13 adds the associated port 132 of the MAC address after hopping into the hop port set, sets the adding serial number of the port to 2, starts timing, and performs S507.

S505: The switch 13 judges whether the associated port of the MAC address after hopping already exists in the hop port set. If yes, go to step S507; if not, go to step S506.

S506: The switch 13 adds the port 133 into the hop port set, and sets the serial number of the port 133 to 3 in the order of joining the hop port set.

S507: The switch 13 counts the total number of hops of the associated port of the MAC address in the specified time.

S508: The switch 13 determines whether the total number of hops of the associated port of the MAC address is greater than or equal to a preset threshold. If yes, go to step S509; if not, perform no processing.

S509: The switch 13 determines the port 132 (the port 2) as a loop fault port.

S510: The switch 13 sends loop fault alarm information, and the loop fault alarm information carries information of the port 2.

S511: The switch 13 interrupts services of the port 132 (the port 2).

The hop port set refers to a set of all associated ports of the MAC address that undergo hopping. In this embodiment of the present disclosure, the hop port set includes the port 131, the port 132, and the port 133.

Understandably, although the embodiment of the present disclosure uses the switch 13 as an example to describe the Ethernet loop locating method when the hop port set includes three ports, the method provided by the embodiment of the present disclosure is also applicable to the scenario that the hop port set includes more ports. The order between step S510 and step S511 may be random. That is, step S510 is performed before step S511, or step S511 is performed before step S510; or step S510 and step S511 are performed simultaneously. In FIG. 5, it is assumed that step S510 is performed before step S511.

Through the Ethernet loop locating method provided in this embodiment of the present disclosure, after an Ethernet frame is received, a MAC address is learned according to a source MAC address of the Ethernet frame, and an associated port of the source MAC address is determined as a first port of the MAC address; a port after hopping is used as a second port of the MAC address when the associated port of the MAC address undergoes hopping for a first time after the MAC address is learned; and the second port of the MAC address is determined as a loop fault port if the total number of hops of the associated port of the MAC address in a specified time is greater than or equal to a preset threshold. In this way, after a loop fault occurs on the Ethernet, the loop fault port can be located quickly and precisely without the need of sending a detection message and waiting for a returned message as in the prior art. The precise locating of the loop fault port shortens the troubleshooting time of the loop, and quickens service recovery. Meanwhile, because the service on the loop fault port is interrupted quickly, the loop is disrupted directly, and services of other ports are protected against impact of a broadcast storm.

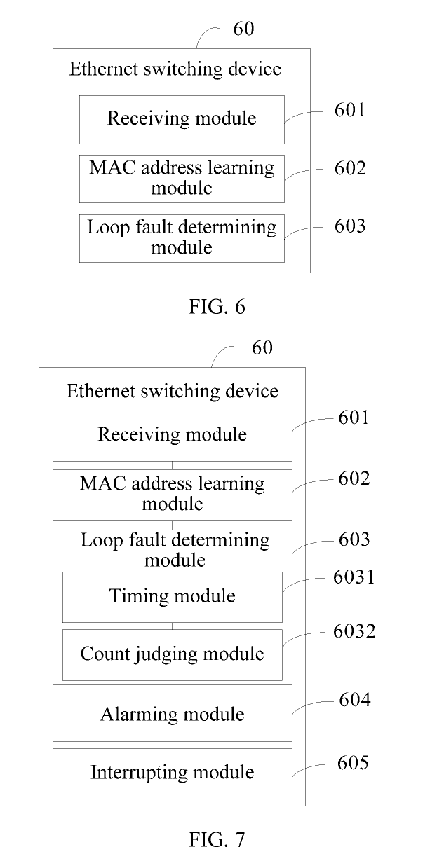

As shown in FIG. 6, an Ethernet switching device 60 provided in an embodiment of the present disclosure includes:

a receiving module 601, configured to receive an Ethernet frame;

a MAC address learning module 602, configured to learn a MAC address according to a source MAC address of the Ethernet frame, and determine a learned associated port of the MAC address as a first port of the MAC address; and

a loop fault determining module 603, configured to: use a port after hopping as a second port of the MAC address when the associated port of the MAC address undergoes hopping for a first time after the MAC address is learned; and determine the second port of the MAC address as a loop fault port if the total number of hops of the associated port of the MAC address in a specified time is greater than or equal to a preset threshold.

Through the Ethernet switching device provided in this embodiment of the present disclosure, after an Ethernet frame is received, a MAC address is learned according to a source MAC address of the Ethernet frame, and an associated port of the source MAC address is determined as a first port of the MAC address; a port after hopping is used as a second port of the MAC address when the associated port of the MAC address undergoes hopping for a first time after the MAC address is learned; and the second port of the MAC address is determined as a loop fault port if the total number of hops of the associated port of the MAC address in a specified time is greater than or equal to a preset threshold. In this way, after a loop fault occurs on the Ethernet, the loop fault port can be located quickly and precisely without the need of sending a detection message and waiting for a returned message as in the prior art. The precise locating of the loop fault port shortens the troubleshooting time of the loop, and quickens service recovery.

Further, as shown in FIG. 7, the loop fault determining module 603 may include:

a timing module 6031, configured to use the port after hopping as a second port of the MAC address and start timing when the associated port of the MAC address undergoes hopping for the first time after the MAC address is learned; and

a count judging module 6032, configured to determine the second port as a loop fault port if the total number of hops of the associated port of the MAC address in a specified time is greater than or equal to a preset threshold.

The Ethernet switching device 60 may further include:

an alarming module 604, configured to send loop fault alarm information after the second port is determined as the loop fault port, where the loop fault alarm information carries loop fault port information; and

an interrupting module 605, configured to interrupt services of the loop fault port after the second port is determined as the loop fault port.

In this way, after a loop fault occurs on the Ethernet, the loop fault port can be located precisely. The precise locating of the loop fault port shortens the troubleshooting time of the loop, and quickens service recovery. Meanwhile, because the service on the loop fault port is interrupted quickly, the loop is disrupted directly, and services of other ports are protected against impact of a broadcast storm.

An Ethernet system provided in an embodiment of the present disclosure includes at least one Ethernet switching device 60.

The Ethernet switching device 60 is configured to: receive an Ethernet frame, learn a MAC address according to a source MAC address of the Ethernet frame, and determine a learned associated port of the MAC address as a first port of the MAC address; use a port after hopping as a second port of the MAC address when the associated port of the MAC address undergoes hopping for a first time after the MAC address is learned; and determine the second port of the MAC address as a loop fault port if the total number of hops of the associated port of the MAC address in a specified time is greater than or equal to a preset threshold.

The Ethernet system provided in an embodiment of the present disclosure includes at least one Ethernet switching device. After an Ethernet frame is received, a MAC address is learned according to a source MAC address of the Ethernet frame, and an associated port of the source MAC address is determined as a first port of the MAC address; a port after hopping is used as a second port of the MAC address when the associated port of the MAC address undergoes hopping for a first time after the MAC address is learned; and the second port of the MAC address is determined as a loop fault port if the total number of hops of the associated port of the MAC address in a specified time is greater than or equal to a preset threshold. In this way, after a loop fault occurs on the Ethernet, the loop fault port can be located quickly and precisely without the need of sending a detection message and waiting for a returned message as in the prior art. The precise locating of the loop fault port shortens the troubleshooting time of the loop, and quickens service recovery.

Persons of ordinary skill in the art should understand that all or a part of the steps of the method according to the embodiments of the present disclosure may be implemented by a program instructing relevant hardware. The program may be stored in a computer readable storage medium. When the program runs, the program executes the steps of the method specified in any embodiment of the present disclosure. The storage medium may be any medium capable of storing program codes, such as a ROM, a RAM, a magnetic disk, or an optical disk.

The above descriptions are merely exemplary embodiments of the present disclosure, but not intended to limit the protection scope of the present disclosure. Any variations or replacement that can be easily derived by those skilled in the art without departing from the technical solution of the present disclosure shall fall within the protection scope of the present disclosure. Therefore, the protection scope of the present disclosure is subject to the appended claims.

1. An Ethernet loop locating method, comprising:
receiving an Ethernet frame;
learning a MAC address according to a source MAC address of the Ethernet frame;
determining a learned associated port of the MAC address as a first port of the MAC address;
using a port after hopping as a second port of the MAC address when the learned associated port of the MAC address undergoes hopping for a first time after the MAC address is learned; and
determining the second port of the MAC address as a loop fault port if a total number of hops of the learned associated port of the MAC address in a specified time is greater than or equal to a preset threshold.

2. The method according to claim 1, wherein:
the step of learning the MAC address according to the source MAC address of the Ethernet frame com rises adding the learned associated sort of the MAC address into a hop port set that includes all associated ports of the MAC address that undergo hopping.

3. The method according to claim 2, further comprising:
when the learned associated port of the MAC address undergoes hopping for the first time after the MAC address is learned, adding the learned associated port of the MAC address after hopping into the hop port set and using the port after hopping as a second port of the MAC address; and
when the learned associated port of the MAC address undergoes hopping not for the first time and the learned associated port of the MAC address after hopping is not in the hop port set, adding the associated port of the MAC address after hopping into the hop port set.

4. The method according to claim 1, wherein:
after determining the second port as the loop fault port, the method further comprises:
sending loop fault alarm information, wherein the loop fault alarm information carries loop fault port information.

5. The method according to claim 1, wherein:
after the determining the second port as the loop fault port, the method further comprises:
interrupting services of the loop fault port.

6. The method according to claim 1, wherein:
if the total number of hops of the learned associated port of the MAC address in the specified time is less than the preset threshold, the method further comprises resetting a count value to zero without performing any other processing.

7. An Ethernet switching device, comprising:
a receiving module, configured to receive an Ethernet frame;
a MAC address learning module, configured to learn a MAC address according to a source MAC address of the Ethernet frame and determine a learned associated port of the MAC address as a first port of the MAC address; and
a loop fault determining module, configured to use a port after hopping as a second port of the MAC address when the learned associated port of the MAC address undergoes hopping for a first time after the MAC address is learned; and determine the second port of the MAC address as a loop fault port if the total number of hops of the learned associated port of the MAC address in a specified time is greater than or equal to a preset threshold.

8. The device according to claim 7, wherein the loop fault determining module comprises:
a timing module, configured to use the port after hopping as a second port of the MAC address and start timing when the learned associated port of the MAC address undergoes hopping for the first time after the MAC address is learned; and
a count judging module, configured to determine the second port as a loop fault port if the total number of hops of the learned associated port of the MAC address in the specified time is greater than or equal to the preset threshold.

9. The device according to claim 7, wherein the Ethernet switching device further comprises:
an alarming module, configured to send loop fault alarm information after the second port is determined as the loop fault port, wherein the loop fault alarm information carries loop fault port information.

10. The device according to claim 7, wherein the Ethernet switching device further comprises:
an interrupting module, configured to interrupt services of the loop fault port after the second port is determined as the loop fault port.

11. An Ethernet system, comprising at least one Ethernet switching device, wherein:
the Ethernet switching device is configured to: receive an Ethernet frame, learn a MAC address according to a source MAC address of the Ethernet frame, and determine a learned associated port of the MAC address as a first port of the MAC address; use a port after hopping as a second port of the MAC address when the learned associated port of the MAC address undergoes hopping for a first time after the MAC address is learned; and determine the second port of the MAC address as a loop fault port if the total number of hops of the learned associated port of the MAC address in a specified time is greater than or equal to a preset threshold.

12. The system according to claim 11, wherein the Ethernet switching device is specifically configured to receive the Ethernet frame, learn the MAC address according to the MAC address of the Ethernet frame, add the learned associated port of the MAC address into a hop port set, and determine the learned associated port of the MAC address as the first port of the MAC address, wherein the hop port set comprises all associated ports of the MAC address that undergo hopping.

13. The system according to claim 12, wherein
when the associated port of the MAC address undergoes hopping for the first time after the MAC address is learned, the Ethernet switching device is further configured to add the learned associated port of the MAC address after hopping into the hop port set, and use the port after hopping as a second port of the MAC address; and
when the associated port of the MAC address undergoes hopping not for the first time and the associated port of the MAC address after hopping is not in the hop port set, the Ethernet switching device is further configured to add the learned associated port of the MAC address after hopping into the hop port set.

14. The system according to claim 11, wherein after determining the second port as the loop fault port, the Ethernet switching device is further configured to send loop fault alarm information, wherein the loop fault alarm information carries loop fault port information.

15. The system according to claim 11, wherein after determining the second port as the loop fault port, the Ethernet switching device is further configured to interrupt services of the loop fault port.

16. The system according to claim 11, wherein if the total number of hops of the associated port of the MAC address in the specified time is less than the preset threshold, the Ethernet switching device is further configured to reset a count value to zero without performing any other processing.
